(19) United States
(12) Patent Application Publication
(10) Pub. No.: US 2004/0093736 A1
(43) Pub. Date: May 20, 2004

(54) Portable cutting device

(76) Inventor: Yung - Pin Kuo, Chang Hwa City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/298,519

(22) Filed: Nov. 19, 2002

(51) Int. Cl. B26D 3/16; B23D 21/06

(52) U.S. Cl. 30/92; 30/280; 30/278

(57) ABSTRACT

A cutting device includes a base and a slit is defined longitudinally in the top surface. A groove is defined transversely in the top surface of the base and communicates with the slit at an angle. A rod is connected between two lugs on the top surface of the base and a spring is mounted to the rod. A handle has a passage through which the rod extends. A blade is fixedly connected to an underside of the handle and movably inserted in the slit. A pipe or cable is put in the groove and cut by the blade by moving the handle.

### FIELD OF THE INVENTION

The present invention relates to a portable cutting device for cutting pipes or cables more conveniently.

### BACKGROUND OF THE INVENTION

A conventional way to cut pipes made of plastic or rubber, or cables including metal wires is to manually use a paper blade. Although the paper blade is able to cut the pipes or cables, it requires a lot of effort and the cutting surface is generally a rough surface which is not satisfied because of its bad quality. Besides, it the user wants to cut a lot of pipes or cables, the paper blade is not an ideal tool to do the job.

The present invention intends to provide a cutting device that is portable and may cut the pipes or cables neatly.

### SUMMARY OF THE INVENTION

In accordance with one aspect of the present invention, there is provided a cutting device which comprises a base having two lugs and a slit is defined longitudinally in a top surface of the base. A groove is defined transversely in the top surface of the base and communicates with the slit at an angle. A rod is connected between the two lugs and a handle has a passage through which the rod extends. A blade is fixedly connected to an underside of the handle and movably inserted in the slit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the cutting device of the present invention;

FIG. 2 is an exploded view to show the cutting device of the present invention;

FIG. 3 is a top view to show the cutting device of the present invention;

FIG. 4 is a cross sectional view to show the blade is clamped at the base;

FIGS. 5A to 5C show an object in the groove is cut by moving the handle, and

FIG. 6 shows the base of the cutting device is fixed to a board.

### DETAILED DESCRIPTION OF THE PREFERRED EMBODIMENT

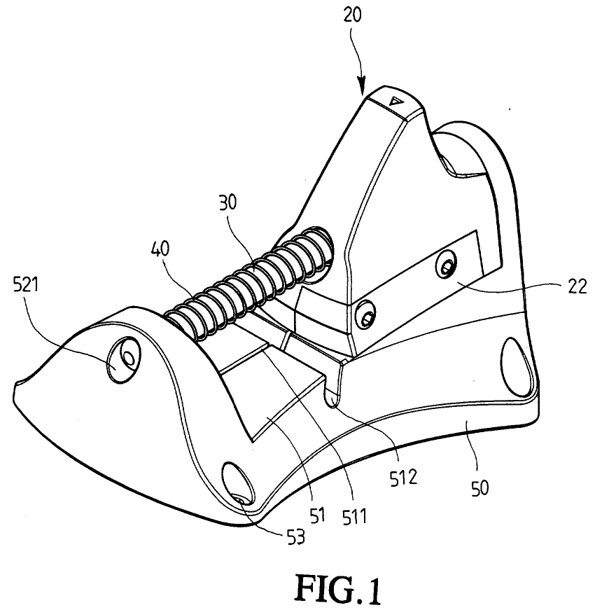

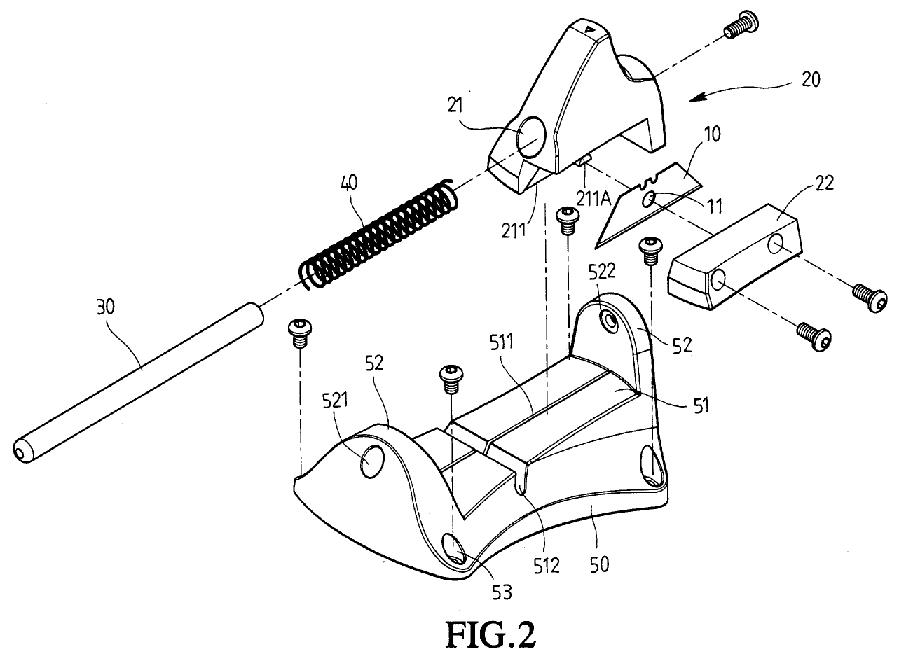

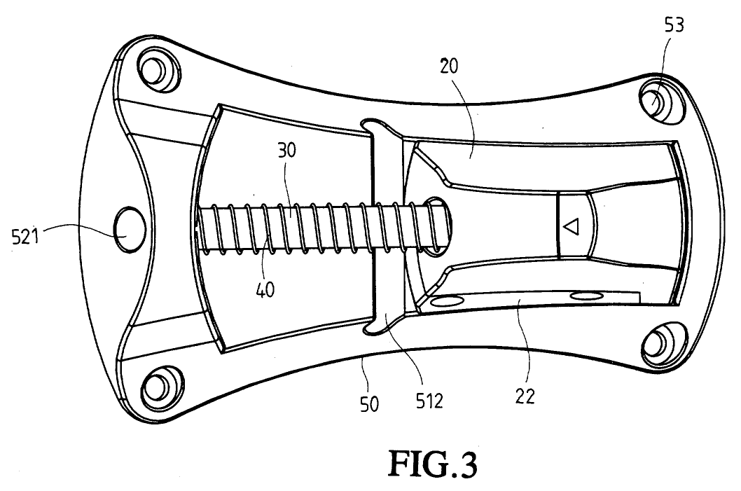

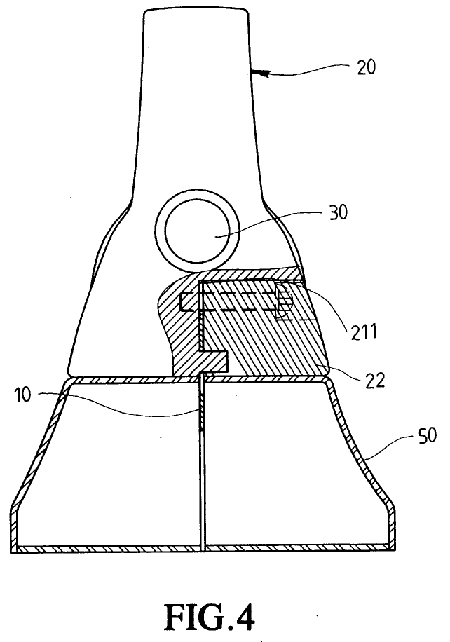

Referring to FIGS. 1 to 5A, the cutting device of the present invention comprises a base 50 having two lugs 52 extending from two ends of a top surface 51 thereof and a slit 511 is defined longitudinally in the top surface 51 of the base 50. A groove 512 is defined transversely in the top surface 51 of the base 50 and communicates with the slit 511 at an angle.

A rod 30 extends through a hole 521 in one of the lugs 52 and fixed to a recess 522 in the other lug 52. A spring 40 is mounted onto the rod 30. A handle 20 has a passage 21 through which the rod 30 extends and the spring 40 is biased between an end of the handle 20 and one of the two lugs 52. The handle 20 has a positioning wall 211 extending from the underside thereof and a protrusion 211A extends from the positioning wall 211. A side of a blade 10 contacts on the positioning wall 211 and a hole 11 through the blade 10 is mounted on the protrusion 21 1 A. A positioning member 22 clamps the blade 10 with the positioning wall 211 by screws 22. The blade 10 is movably inserted in the slit 511.

It is to be noted that the top surface 51 is an inclined surface and the rod 30 is located parallel with the top surface 51. A cutting edge of the blade 10 is located on a horizontal plain (not shown) and an angle is defined between the cutting edge of the blade 10 and the top surface 51.

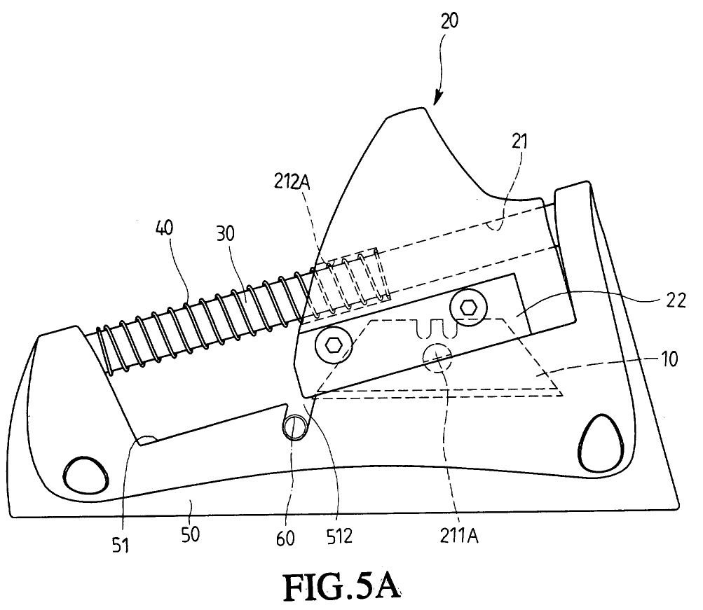

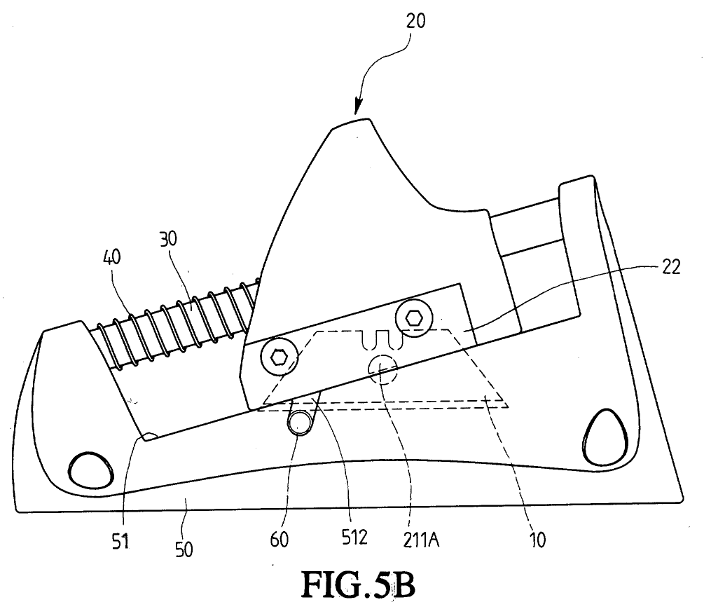

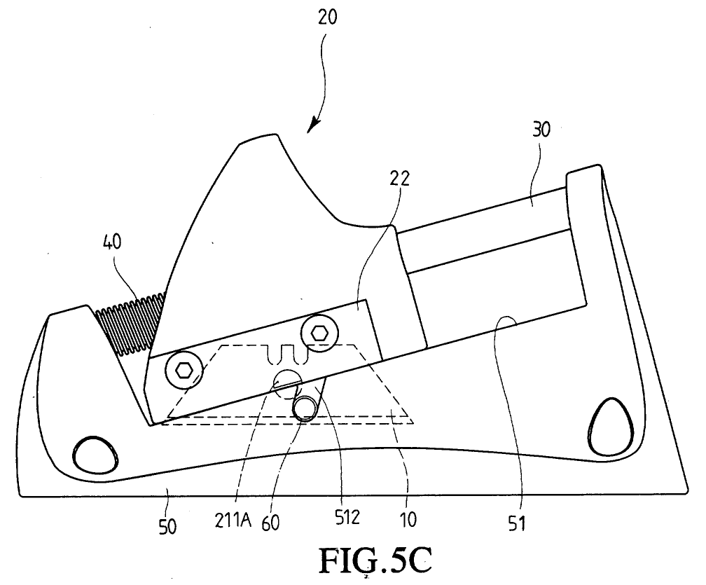

Referring to FIGS. 5B and 5C, an object 60 such as a pipe of a cable is put in the groove 512 and the handle 20 is then moved toward the lower end along the rod 30, the object 60 is cut by the cutting edge of the blade 10. When the handle 20 is released, the handle 20 is pushed back by the spring 40.

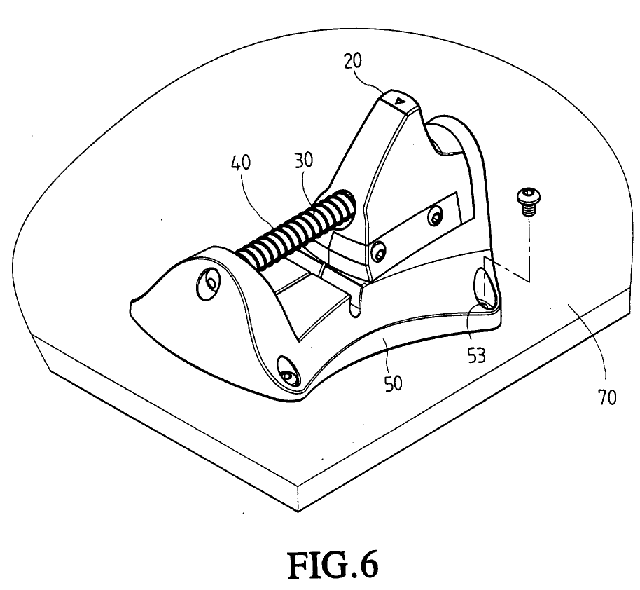

Further referring to FIG. 6, the base 50 has four holes 53 at four corners thereof so that it is easily to be fixed on a board 70 as needed.

While we have shown and described the embodiment in accordance with the present invention, it should be clear to those skilled in the art that further embodiments may be made without departing from the scope of the present invention.

What is claimed is:

1. A cutting device comprising:
a base having two lugs extending from two ends of a top surface thereof and a slit defined longitudinally in the top surface of the base, a groove defined transversely in the top surface of the base and communicating with the slit at an angle;
a rod connected between the two lugs, a handle having a passage through which the rod extends, and
a blade fixedly connected to an underside of the handle and movably inserted in the slit.

2. The device as claimed in claim 1, wherein the handle has a positioning wall extending from the underside thereof and a side of the blade contacts on the positioning wall, a positioning member clamping the blade with the positioning wall 211 by screws.

3. The device as claimed in claim 2 further comprising a protrusion extending from the positioning wall and the blade having a hole through which the protrusion extends.

4. The device as claimed in claim 1, wherein the top surface is an inclined surface and the rod is located parallel with the top surface.

5. The device as claimed in claim 1, wherein an angle is defined between a cutting edge of the blade and the top surface.

6. The device as claimed in claim 1, wherein a spring is mounted onto the rod and the spring is biased between an end of the handle and one of the two lugs.
